(19) United States
(12) Patent Application Publication
(10) Pub. No.: US 2025/0046101 A1
(43) Pub. Date: Feb. 6, 2025

(54) DEVICE FOR RECOGNIZING OBJECT

(71) Applicant: TOYOTA JIDOSHA KABUSHIKI KAISHA, Toyota-shi (JP)

(72) Inventor: Wataru KAWASHIMA, Nisshin-shi (JP)

(21) Appl. No.: 18/739,384

(22) Filed: Jun. 11, 2024

(30) Foreign Application Priority Data
Aug. 1, 2023 (JP) 2023-125743

(51) Int. Cl. G06V 20/56; G06T 7/73; G06V 10/22; G06V 20/58

(52) U.S. Cl. CPC G06V 20/588; G06T 7/73; G06V 10/22; G06V 20/582; G06V 20/584; G06T 2207/30256

(57) ABSTRACT

A device for recognizing an object, includes an image sensor configured to acquire an image of a travel direction of a vehicle, a controller configured to clip a target region from an image acquired by the image sensor and configured to set the target region as a target image, the target region including a first region below a center of the image and a second region above the center of the image, the second region being adjacent to the first region and having an area smaller than that of the first region, and a model configured to receive the target image and position of the target region and configured to output a recognition result for a lane line of a road and at least one of a traffic light and a signboard.

### CROSS-REFERENCE TO RELATED APPLICATION

This application is based on Japanese Patent Application No. 2023-125743 filed with Japan Patent Office on Aug. 1, 2023, the entire contents of which are hereby incorporated by reference.

### TECHNICAL FIELD

The present disclosure relates to a device for recognizing object.

### BACKGROUND

Japanese Patent Application Publication No. 2022-084282 discloses a device that recognizes an object based on an image captured by a camera. This device recognizes the object in the image using CNN (Convolutional Neural Network). This device generates an inverted image obtained by vertically inverting the camera image, and inputs the inverted image to CNN model. In an environment where the upper limit of the number of recognizable objects is determined, this device preferentially recognizes objects appearing in a region in the lower half of the screen by using an inverted image.

### SUMMARY

The object to which the driver pays attention during driving of the vehicle also includes a traffic light or a signboard appearing in the region of the upper half of the screen. Therefore, it is required to recognize not only an object appearing in the region of the lower half of the screen but also a traffic light or a signboard appearing in the region of the upper half of the screen. However, when the entire screen is set as a processing target, there is a concern that a calculation load may increase. The present disclosure provides a device capable of reducing a load of calculation for recognizing an object.

A device for recognizing an object according to an embodiment of the present disclosure includes an image sensor, a controller, and a model. The image sensor acquires an image of a travel direction of a vehicle. The controller clips a target region from an image acquired by the image sensor and sets the target region as a target image. The target region includes a first region below a center of the image and a second region above the center of the image. The second region is adjacent to the first region and has an area smaller than that of the first region. The model is configured to receive the target image and position of the target region and output a recognition result related to a lane line of a road and at least one of a traffic light and a signboard.

According to the present disclosure, there is provided a technique capable of reducing a load of an operation for recognizing an object.

### BRIEF DESCRIPTION OF DRAWINGS

FIG. 1 is a block diagram illustrating an example of a configuration of a vehicle including a recognition device according to an embodiment.

FIG. 2 is a diagram illustrating an example of a target region in the camera image.

FIG. 3 is a diagram illustrating another example of the target region in the camera image.

FIG. 4 is a diagram illustrating another example of the target region in the camera image.

FIG. 5 is a flowchart showing an example of the operation of the recognition device.

### DETAILED DESCRIPTION

Hereinafter, embodiments of the present invention will be described with reference to the drawings. In the description of the drawings, the same elements are denoted by the same reference numerals, and redundant description is not repeated.

### [Configuration of Vehicle]

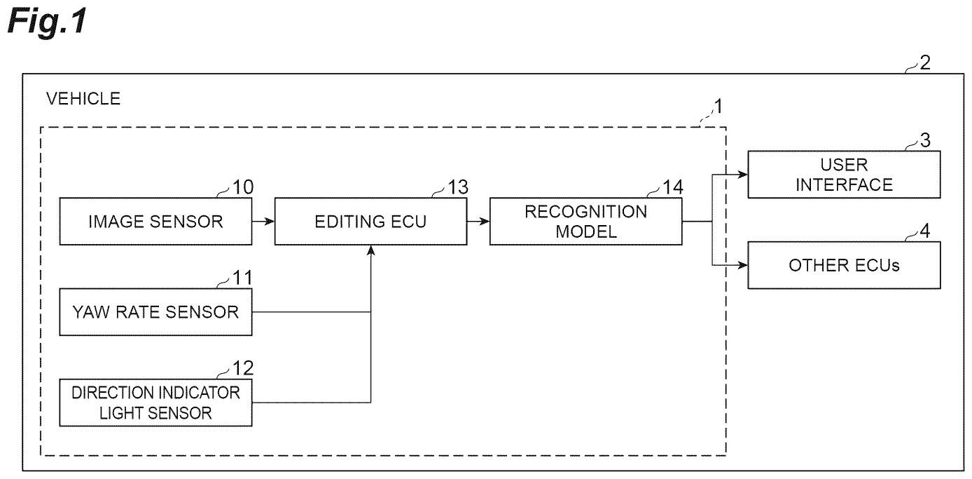

FIG. 1 is a block diagram illustrating an example of a configuration of a vehicle including a device according to an embodiment. As shown in FIG. 1, a recognition device 1 (an example of a device) is mounted on a vehicle 2 as an example. The vehicle 2 is an autonomous driving vehicle by way of example. The vehicle 2 is not limited to an autonomous driving vehicle, and may be a vehicle that assists driving operation. The assistance of the driving operation includes a case in which only notification of information is performed.

The recognition device 1 includes an image sensor 10, a yaw rate sensor 11, a direction indicator light sensor 12, an editing ECU 13 (an example of a controller), and a recognition model 14 (an example of a model). The electronic control unit (ECU) includes a central processing unit (CPU), a read only memory (ROM), a random-access memory (RAM), and a controller area network (CAN). The electronic control unit includes a communication circuit and the like. The recognition device 1 may be free of the yaw rate sensor 11 and the direction indicator light sensor 12.

The image sensor 10 is a camera as an example. The image sensor 10 acquires an image of the travel direction of the vehicle 2. Hereinafter, the image acquired by the image sensor 10 is referred to as a camera image. The yaw rate sensor 11 detects the yaw rate of the vehicle 2. The direction indicator light sensor 12 detects the direction of a direction indicator light indicating the travel direction of the vehicle 2.

The editing ECU 13 generates a target image by clipping a target region from the camera image. The target image is an image to be subjected to recognition processing by the recognition model 14. The target region includes a first region and a second region. The first region is a region below the center of the camera image. The second region is a region above the center of the camera image. The second region is adjacent to the first region and has an area smaller than that of the first region. That is, the target region has a convex shape, an L shape, or a shape obtained by inverting the L shape from side to side.

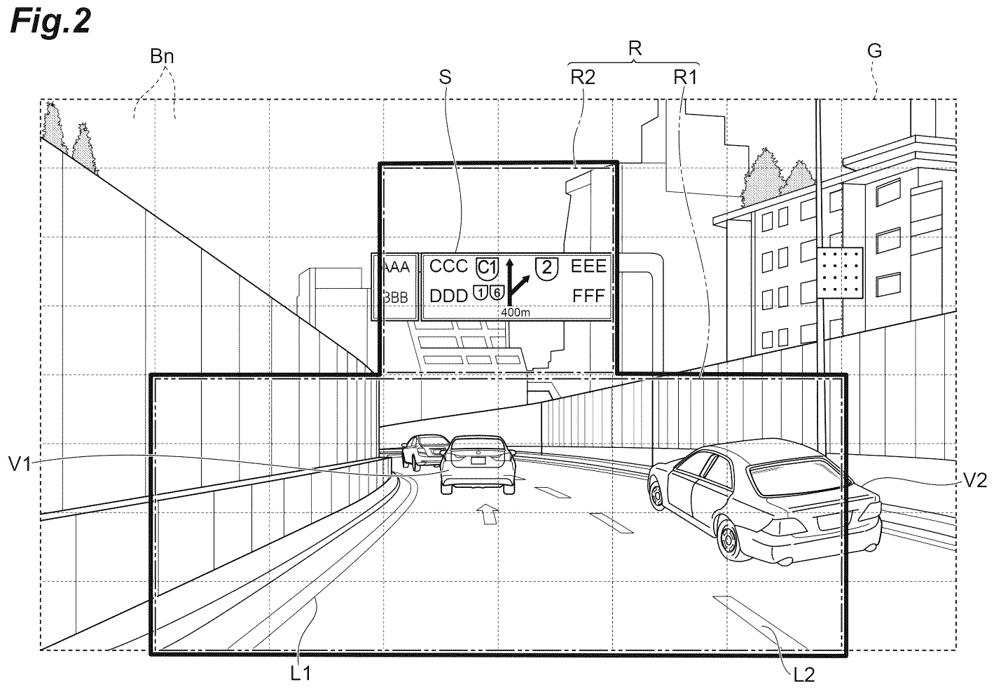

As an example, the editing ECU 13 divides the camera image into blocks and specifies a region on the image based on an identifier assigned to the block. FIG. 2 is a diagram illustrating an example of a target region in a camera image. As shown in FIG. 2, a camera image G is divided into blocks. As an example, camera image is divided into a matrix of 8 rows and 8 columns. An identifier is assigned to the block. For example, the identifier of the leftmost block in the uppermost row is B1. The identifier of the block adjacent to the right side of a block B1 is B2. In this way, an identifier Bn is given to the block. The editing ECU 13 can designate the region at an arbitrary position using the identifier Bn of the block.

The editing ECU 13 determines the position of a first region R1, which is a region below the center of the camera image G, and the position of a second region R2, which is a region above the center of the camera image G. The first region R1 is provided at a position lower than the center of the camera image G. In general, lane lines L1, L2 of the road appear on the lower side of the center of the camera image G. That is, the first region R1 is set in expectation that the lane lines L1, L2 of the road are reflected. The first region R1 may be set up to include a preceding vehicle V1 and an adjacent vehicle V2.

The second region R2 is provided at a position above the center of the camera image G. In general, a signboard S and signal of the traffic light appear above the center of the camera image G. In other words, the second region R2 is set with the expectation that the signboard S and the traffic light will appear. The signboard S and the traffic light are also generally smaller than interval between the lane lines L1, L2 on road. Therefore, the second region R2 can be made smaller in area than the first region R1. The second region R2 is adjacent to the first region R1. A target region R in which the first region R1 and the second region R2 are connected can be handled as one image.

The editing ECU 13 determines the position of the first region R1 and the position of the second region R2 based on, for example, an identifier of block determined in advance as a default.

The editing ECU 13 may change the position of the first region R1 and the position of the second region R2 for each type or specification of the image sensor 10. The type or specification of the image sensor 10 is camera function such as wide angle and telephoto. The image sensor 10 type or specification may be distinguished by an identifier. For example, the editing ECU 13 has a table that stores an identifier of the image sensor 10, a position of the first region R1, and a position of the second region R2 in association with each other. The table is stored in the storage unit of the ECU. The editing ECU 13 acquires the identifier of the image sensor 10, refers to the table based on the acquired identifier, and determines the position of the first region R1 and the position of the second region R2. Thus, the optimum the target region R can be set for each the image sensor 10.

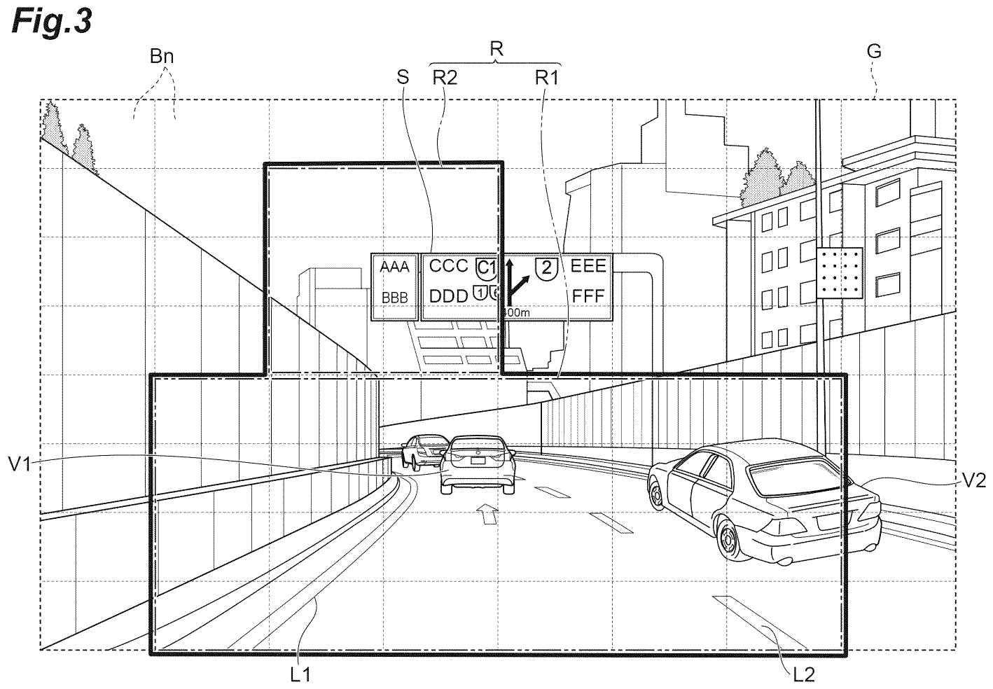

The editing ECU 13 may determine the position of the first region R1 and the position of the second region R2 based on the detection result of the yaw rate sensor 11. For example, the editing ECU 13 determines the turning direction of the vehicle 2 based on the detection result of the yaw rate sensor 11. The editing ECU 13 moves the second region R2 in the turning direction of the vehicle 2. FIG. 3 is a diagram illustrating another example of the target region in the camera image. The scene of FIG. 3 is assumed to be a scene in which the vehicle 2 travels while turning to the left. In this case, as shown in FIG. 3, the position of the second region R2 is shifted to the left by one block compared to the target region R shown in FIG. 2. This allows the left portion of the signboard S to fit into the second region R2. The editing ECU 13 may also change the position of the first region R1. In the editing ECU 13, the movement amount of the first region R1 and the movement amount of the second region R2 are determined according to the amount of the yaw rate of the vehicle 2, and the movement amount of the second region R2 may be set to be larger than the movement amount of the first region R1. This allows the editing ECU 13 to more accurately capture the signboard S and the traffic light and include the signboard S and traffic light in the second region R2 while including the lane lines L1, L2 in the first region R1. In this way, it is possible to set the target region R in accordance with the movement of the vehicle 2.

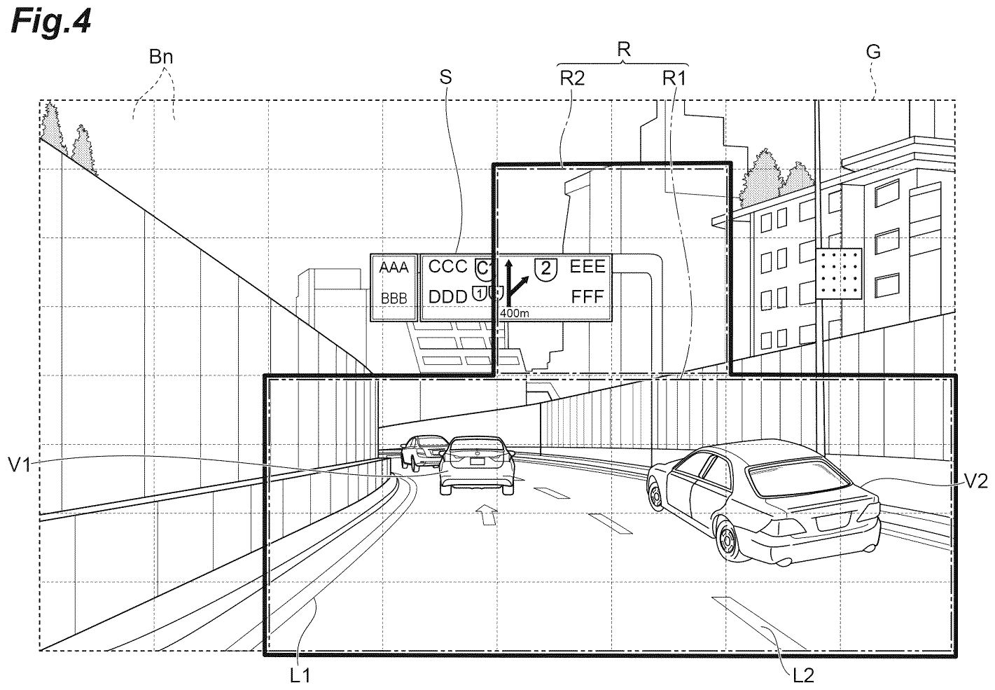

The editing ECU 13 may determine the first region R1 position and the second region R2 position based on the direction indicated by the direction indicator light detected by the direction indicator light sensor 12. For example, the editing ECU 13 moves the second region R2 in the same direction as the direction indicator light. FIG. 4 is a diagram illustrating another example of the target region in the camera image. It is assumed that the scene in FIG. 4 is a scene in which the direction indicator light so that the vehicle 2 moves to the right lane. In this case, as shown in FIG. 4, the position of the first region R1 and the position of the second region R2 are moved to the right by one block as compared with the target region R shown in FIG. 2. This allows the adjacent lane and the adjacent vehicle V2 to fit in the first region R1 and the right portion of the signboard S to fit in the second region R2. In this way, it is possible to set the target region R in accordance with the movement of the vehicle 2.

The recognition model 14 is a pretrained model. The recognition model 14 is trained by machine learning or the like based on teacher data. The recognition model 14 may be CNN model. The recognition model 14 receives (inputs) the target image generated by the editing ECU 13 and the position of the target region. The position of the target region is the identifier Bn of the block described above. The recognition model 14 is trained to output a recognition result for the lane lines L1, L2 of the road and at least one of the signboard S and traffic light when the target image and the position of target region are input. The pretrained recognition model 14 is provided to the vehicle 2 through communication or the like.

The recognition model 14 outputs the position of the lane lines L1, L2 of road, information of the signboard S, signal information of traffic light, and the like as the recognition result. The recognition result is output to a user interface 3. The user interface 3 is, for example, a display, a speaker, or the like. The user interface 3 notifies the driver of the recognition result. Alternatively, the recognition result is output to other ECUs 4. The other ECUs 4 include, for example, an autonomous driving ECU.

Note that the editing ECU 13 may determine the position of the first region R1 and the position of the second region R2 based on the positions of the lane lines L1, L2 recognized by the recognition model 14. For example, it is assumed that the scene of FIG. 4 is a scene in which the vehicle 2 moves to the right lane. In this case, the lane lines L1, L2 move relatively to the left. Therefore, the editing ECU 13 moves the position of the first region R1 and the position of the second region R2 in a direction opposite to the direction in which the recognized positions of the lane lines L1, L2 move. For example, as shown in FIG. 4, compared with the target region R shown in FIG. 2, the position of the first region R1 and the position of the second region R2 are moved to the right by one block. This allows the adjacent lane and the adjacent vehicle V2 to fit in the first region R1 and the right portion of the signboard S to fit in the second region R2. In this way, it is possible to set the target region R in accordance with the movement of the vehicle 2.

### [Operation of Recognition Device]

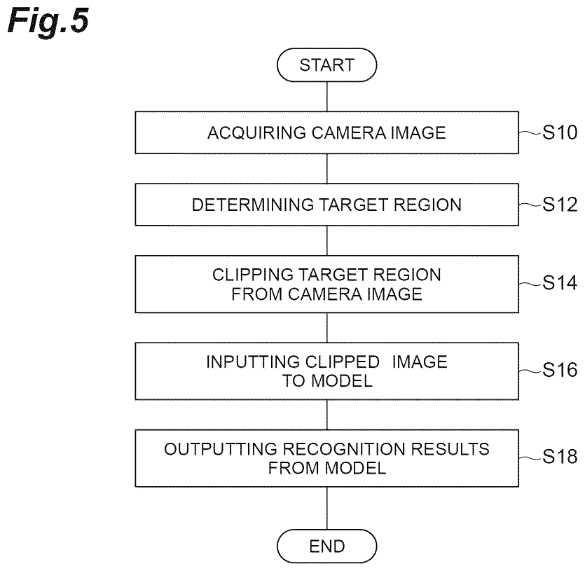

FIG. 5 is a flowchart showing an example of the operation of the recognition device. The flowchart shown in FIG. 5 is started when the recognition device 1 receives a start instruction operation.

As shown in FIG. 5, first, the recognition device 1 the image sensor 10 acquires the camera image G as a step S10. Subsequently, the editing ECU 13 determines the target region R as step S12.

In the case of the editing ECU 13, the target region R is clipped from the camera image G as a step S14 and used as a target image. The recognition model 14 inputs the target image clipped in step S16 as step S14. The recognition model 14 outputs the recognition result for the lane lines L1, L2 of the road and at least one of the signboard S and traffic light as step S18. When step S18 ends, the flowchart shown in FIG. 5 ends.

### [Summary of Embodiment]

According to the recognition device 1, the target region R including the first region R1 on the lower side of the center of the camera image G and the second region R2 which is a region on the upper side of the center of the camera image G, is adjacent to the first region R1, and has an area smaller than the first region R1 is clipped from the camera image G acquired by the image sensor 10, and is set as a target image. By making the target image into an image having a convex shape or the like, it is possible to reduce the region to be calculated while capturing the lane lines L1, L2, and at least one of traffic light and the signboard S in the image. Therefore, the recognition model 14 can reduce the load of calculation for recognizing the lane lines L1, L2, and at least one of traffic light and the signboard S, compared to a case where calculation is performed on the entire image of one sheet.

While exemplary embodiments have been described above, various omissions, substitutions, and changes may be made without being limited to the exemplary embodiments described above.

The present disclosure includes the following aspects.

### [Clause 1]

A device for recognizing an object, comprising:
an image sensor configured to acquire an image of a travel direction of a vehicle;
a controller configured to clip a target region from an image acquired by the image sensor and configured to set the target region as a target image, the target region including a first region below a center of the image and a second region above the center of the image, the second region being adjacent to the first region and having an area smaller than that of the first region; and
a model configured to receive the target image and position of the target region and configured to output a recognition result for a lane line of a road and at least one of a traffic light and a signboard.

### [Clause 2]

The device according to clause 1, wherein the controller includes a table storing an identifier of the image sensor, the position of the first region, and the position of the second region in association with each other, and determines the position of the first region and the position of the second region based on the identifier of the image sensor and the table.

### [Clause 3]

The device according to clause 1 or 2, further comprising a yaw rate sensor configured to detect a yaw rate of the vehicle, wherein the controller determines the position of the first region and the position of the second region based on the yaw rate of the vehicle.

### [Clause 4]

The device according to any one of clauses 1 to 3, further comprising a sensor configured to detect a direction of a direction indicator light indicating a travel direction of the vehicle, wherein the controller determines the position of the first region and the position of the second region based on the direction indicated by the direction indicator light.

### [Clause 5]

The device according to any one of clauses 1 to 4, wherein the controller determines the position of the first region and the position of the second region based on position of the lane line recognized by the model.

What is claimed is:

1. A device for recognizing an object, comprising:
an image sensor configured to acquire an image of a travel direction of a vehicle;
a controller configured to clip a target region from an image acquired by the image sensor and configured to set the target region as a target image, the target region including a first region below a center of the image and a second region above the center of the image, the second region being adjacent to the first region and having an area smaller than that of the first region; and
a model configured to receive the target image and position of the target region and configured to output a recognition result for a lane line of a road and at least one of a traffic light and a signboard.

2. The device according to claim 1, wherein the controller includes a table storing an identifier of the image sensor, the position of the first region, and the position of the second region in association with each other, and determines the position of the first region and the position of the second region based on the identifier of the image sensor and the table.

3. The device according to claim 1, further comprising a yaw rate sensor configured to detect a yaw rate of the vehicle, wherein the controller determines the position of the first region and the position of the second region based on the yaw rate of the vehicle.

4. The device according to claim 1, further comprising a sensor configured to detect a direction of a direction indicator light indicating a travel direction of the vehicle, wherein the controller determines the position of the first region and the position of the second region based on the direction indicated by the direction indicator light.

5. The device according to claim 1, wherein the controller determines the position of the first region and the position of the second region based on position of the lane line recognized by the model.
